(19) United States
(12) Patent Application Publication
(10) Pub. No.: US 2003/0014311 A1
(43) Pub. Date: Jan. 16, 2003

(54) Method and apparatus for rewarding contributors

(76) Inventor: James Chien Liang Chua, Singapore (SG)

Correspondence Address: SUGHRUE MION, PLLC, 2100 PENNSYLVANIA AVENUE, N.W., WASHINGTON, DC, 20037, US

(21) Appl. No.: 10/204,470

(22) PCT Filed: Dec. 20, 2000
(86) PCT No.: PCT/SG00/00198

(51) Int. Cl. G06F 17/60

(52) U.S. Cl. 705/14

(57) ABSTRACT

The present invention provides a method and apparatus for rewarding a contributor for contributing one or more contributions to an electronic publishing environment, the method comprising calculating a reward for the contributor that depends on one or more criteria selected form the group comprising the quantity of the contributions and the quality of each of the contributions.

### FIELD OF THE INVENTION

The present invention relates to method and apparatus for rewarding contributors in electronic publishing environments such as, for example, an online discussion forum or internet publishing site. The invention relates in particular to forums or news sites, on the internet, online systems and any LAN or computer networks.

One existing technique for rewarding a contributor, such as an author, is to pay the author according to the number of copies of that author's work sold by the publisher according to an agreed sum per copy. The calculation of the payment per copy may depend on the author's previous success. In other existing systems, critics (including members of the public) may contribute critiques of an author's work, but at most the critic is paid by another publisher—such as that of a journal of literary criticism—and not by the publisher of the author's work.

The current forums available electronically are usually run without any direct profit incentives for authors or readers. Their benefit comprises simply the provision of discussions online and the sharing of ideas and insights between participants.

It is an object of the present invention to provide a method and apparatus for rewarding a contributor (such as an author) of an contribution to an electronic publishing environment by rewarding according one or more of a number of criteria, such as accesses by readers, responses by readers, critical approval by readers, or reliability of criticism.

It is a further object of the present invention to provide a method and apparatus for rewarding a reader of an electronic publishing environment by rewarding the reader according one or more of a number of criteria, such as number of accesses by the reader or the reliability of the reader's assessment of contributions.

### SUMMARY OF THE INVENTION

The present invention provides, therefore, a method of rewarding a contributor for contributing one or more contributions to an electronic publishing environment, comprising:

calculating a reward for said contributor that depends on one or more criteria selected from the group comprising the quantity of said contributions and the quality of each of said contributions.

A contribution by a contributor that is an author is an item that could be, for example, an article, a piece of criticism, a letter or a response to an earlier item. Its content might comprise a written essay, links to other web sites, pictures or any other means of expressing an idea. The electronic publishing environment may comprise an online forum in the form of a platform to allow the general public or a section of the public to post items. For example in the context of the internet, the electronic publishing environment might be a newsgroup, a chat room, a news site, or some other setting where people can register themselves, post items and initiate discussion. The forum can be restricted to special interest groups, companies or can be open to the general public.

A contribution by a contributor that is a reader may be an assessment of an item or the contribution may simply be the act of reading that item.

Preferably, when said criteria comprise or include said quality of each of said contributions, said method includes determining said quality of each of said contributions. Preferably, when said criteria comprise or include said quantity of said contributions, said method includes determining said quantity of said contributions.

Preferably said method includes providing said reward, or initiating the provision of said reward.

Thus, when said reward is financial, the computing means may be configured to initiate the crediting of the reward to the contributor's nominated bank account. If the reward is not financial, the reward can be recognition, by giving a contributor a score or forwarding the respective contribution to another party; preferably the computing means is operable to do so may automatically, such as by email.

Preferably the quality of a respective contribution that is an item by an author depends on the number of accesses of said respective item by a reader or readers. Preferably said number of accesses comprises a number of accesses by unique readers.

Preferably, when the contributor is an author, the quality of a respective contribution depends on a critical score derived from reader scoring of said respective contribution. Preferably said critical score is derived from a plurality of attribute scores provided by one or more readers, whereby each of said readers scores each of a plurality of attributes of said respective contribution.

Thus, when the contributor is an author, the higher the critical score, the greater can the reward be made.

Preferably, when the contributor is an author, the quality of a respective item depends on the number of subsequent contributions commenting on or responding to said respective contributions and contributed by other contributors. Thus, the method can follow threads a credit the original contributor according to the number of postings prompted by an initial posting.

Preferably, when said criteria comprise or include said quality of contributions that is assessments of contributions by readers, said method includes determining said quality of said assessments of said contributions.

Preferably, the assessment of a respective reader of a respective contribution depends on a score derived from said respective reader scoring said contribution. Preferably said score is derived from a plurality of attributes of said contribution, whereby said quality then depends on proximity of said score to an average of scores provided by all readers of said respective contribution.

Preferably said reward is a financial reward, whereby said method includes determining income derived from or associated with said publishing environment over a period of time or accounting period, and determining said reward on the basis of said income.

The income may be derived from advertising or sales from the environment, which will typically be a web site, or through any other means. The period of time may be fixed, such as a day, week, etc., or may itself depend on or be the period for which the item is accessible.

The reward may also comprise recognition from scoring each contributor (whether author or reader).

The reward may also include forwarding a respective contribution to a further party, such as another publisher, a funding agency, or a prize awarding organization. Preferably said further party is selected according to at least the quality of said items, whereby the greater the quality the more prestigious the further party.

In one embodiment, said contributor is one of a plurality of like contributors, and the method includes calculating a respective reward for each of said contributors, wherein said rewards are derived from a reward pool for distribution amongst said contributors.

The present invention also provides an apparatus for rewarding a contributor of one or more contributions, comprising:

computing means configured or operable to calculate a reward for said contributor that depends on one or more criteria selected from the group comprising the quantity of said contributions and the quality of each of said contributions.

Preferably, when said criteria comprise or include said quality of each of said contributions, said computing means is configured or operable to receive or calculate values indicative of the quality of each of said items, to thereby determine said quality, and to calculate a reward for said contributor. Preferably, when said criteria comprise or include said quantity of said contributions, said computing means is configured or operable to receive or calculate values indicative of said quantity of said contributions.

Typically said computing means will be at least one computer connected to or connectable to the internet. Preferably said computing means includes means for providing said reward, or initiating the provision of said reward.

Preferably the quality of each of said contributions that are items by contributors that are authors depends on the number of accesses of each of said respective items by readers.

Preferably said number of accesses comprises a number of accesses by unique readers.

Preferably, when the contributor is an author, the quality of a respective item depends on a score derived from reader scoring of said respective item. Preferably said score is derived from a plurality of attribute scores provided by one or more readers, whereby each of said readers scores each of a plurality of attributes of said respective item.

Preferably, when the contributor is an author, the quality of a respective contribution depends on the number of subsequent contributions commenting on or responding to said respective contribution and contributed by other contributors.

Preferably, when said criteria comprise or include said quantity of accesses (one way for a reader to make a contribution) by a contributor that is a reader of said electronic publishing environment, said method includes determining said quantity of said accesses by said reader of unique contributions.

Preferably, when said criteria comprise or include said quality of assessment of contributions (another way in which a reader may make a contribution) by reader, said method includes determining said quality of said assessment of said contributions.

Preferably, the assessment of a respective reader of said contribution depends on a score derived from said reader scoring said contribution. Preferably said score is derived from a plurality of attributes of said item, whereby said quality then depends on proximity of the score to an average of the scores of all readers of said contribution.

Preferably said reward is a financial reward, whereby said apparatus is operable to determine income derived from or associated with said publishing environment over a period of time, and to determine said reward on the basis of said income.

Alternatively said reward comprises giving recognition to authors and readers by scoring them.

Alternatively said reward comprises forwarding said items to a further party, such as another publisher, a funding agency., or a prize awarding organization. Preferably said further party is selected according to said quality of said items, whereby the greater the quality the more prestigious the further party.

In one embodiment, said contributor is one of a plurality of like contributors, and the computing means is operable to calculate a respective reward for each of said contributors, wherein said rewards are derived from a reward pool for distribution amongst said contributors.

### BRIEF DESCRIPTION OF THE DRAWING

In order that the present invention may be more clearly ascertained, preferred embodiments will now be described, by way of example only, with reference to the accompanying drawing, in which:

FIG. 1 is a schematic representation of a system for rewarding contributors to an online forum according to a preferred embodiment of the present invention; and

FIG. 2 is a schematic representation of one possible relationship between multiple items published in an electronic publishing environment within a single thread.

### DETAILED DESCRIPTION OF THE PREFERRED EMBODIMENTS

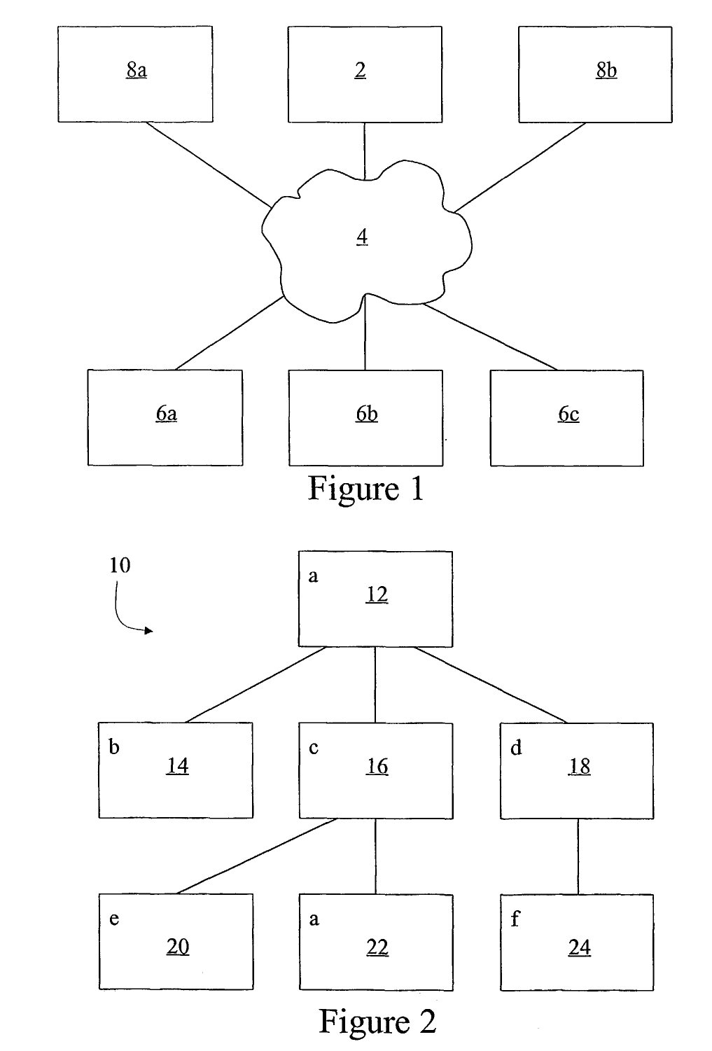

Referring to FIG. 1, a system for rewarding contributors to an online forum according to a preferred embodiment of the present invention includes a server 2 connected ultimately to the internet 4. The server 2 maintains an online forum environment to which users on user computers 6a, 6b and 6c can post items as contributions to the forum. Each user can also access and thereby read or score any posted contribution.

In the preferred embodiment, each user must log into the server 2 before he or she can post contributions or read (and subsequently score) posted items, by providing a username and password (obtained when first logging in). This is principally so that the server 2 can eliminate repeat accesses or scorings by a single user, which could be used to distort or manipulate—deliberately or inadvertently—the determination of the quality of a contribution (whether derived from reader scores or contribution popularity). The use of usernames and passwords also generally increases the security of the server 2. It may be deemed satisfactory, in some embodiments, to employ cookies or the like to discriminate between users, despite the inability of many of such mechanisms to discriminate between different users on the one computer.

In order to determine the quantity of contributions, the server 2 is configured to maintain records of the number of contributed items from any single user (author or reader), whether in the form of an author's contribution, a reader's accessing of an author's contribution, or a reader's critique of an author's contribution.

A first measure of the quality of an author's contribution is based on the number of unique accesses of that contribution during the relevant accounting period. For author i, this number is represented as Ti.

The server 2 is also provided with scoring software for presenting a scoring interface, so that a reader on computer 6a, 6b or 6c can input a score, being an assessment or critique of the quality of a contribution in the form of an article. In one simple embodiment, this score comprises a single numerical rating, but in a preferred embodiment, the server 2 is configured to accept a plurality of separate scores, each relating to a separate attribute of a contribution. The user's overall opinion of the quality of a contribution is then derived from these multiple attribute scores.

Thus, for a contribution by author i, the score Qi is:

$$Qi = \frac{1}{N} {\sum }_{j = 1}^{N} qji$$

where N is the number of submissions by unique readers j within the accounting period (one reader cannot validly submit scores for an item more than once); and

qji is the score given by reader j.

However, qji comprises the mean of the individual attribute scores provided by reader j. Thus:

$$qji = \frac{1}{M} {\sum }_{k = 1}^{M} cjik$$

where M is the number of attributes or characteristics cijk of the contribution of author i that can be evaluated, and each cijk has values ranging from, in this example, −5 to 5. For example, the c1 could represent innovation, c2 general approval rating, c3 ‘well-researched’ rating, etc. If, for example, a particular reader j thinks that an article by author i is innovative and generally approves of the article but regards it as poorly researched, reader j might rate c1, c2 and c3 as 4, 5 and −2 respectively.

A measure of the quality of an author's contribution can also be derived from the sheer popularity of that contribution, based on the number of accesses of the contribution, either overall or by unique users, or on the number of subsequent postings, in the same ‘thread’, in response to that original contribution, excluding any posted by the original author him- or herself.

Thus, FIG. 2 depicts a typical relationship between multiple items 10 posted to a forum beginning with an initial item 12 relating to a new topic or thread by author ‘a’. Authors ‘b’, ‘c’ and ‘d’ may respond to item 12 with items 14, 16 and 18 respectively. Next, authors ‘e’ and ‘a’ may respond to item 16 of author ‘c’ with items 20 and 22 respectively, while author ‘f’ responds with item 24 to item 18 by author ‘d’. The number of items posted in response to the original item 12 by author ‘a’ (preferably excluding additional contribution 22 by author ‘a’) is counted and credited as indicative of the quality of item 12, on the basis that the better the item, the more discussion or responses will be generated. For author i, the number of such follow up items is terms Di. In FIG. 2, Da=5, Db=0, Dc=2 and Dd=1.

Each of these measures of the quality of an author's contribution is weighted according to the preference of the forum. In this embodiment, the total quality Ri of an article by author i is deemed to be:

Ri=Ti+Di+(Qi/5)(Ti+Di)/2

where the division by 5 in this example is due to Q's having the range of −5 to 5.

Consequently the total reward for author i is:

$$TRi = {\sum }_{articles}^{w} Ri$$

where w is the number of articles contributed by author i.

The quality of a reader's contribution or critique (that is, a score comprising one or more attribute scores) is determined from how closely the attribute scores agree with the attribute scores inputted by other readers of the same contribution. At the end of any assessment period, mean values of each attribute score are determined, and—for any particular reader and author's contribution—the departure of each attribute score from the mean score for that attribute assessed.

The rewards of readers are calculated in several ways. The number (i.e. quantity) of articles Ei accessed by each reader i during a particular accounting period can be calculated.

Each reader's effort in participating (i.e. quantity of contributions in the form of accesses) can be measured, as well as the accuracy of the scores assigned by each reader to each of the articles' attributes. Each reader can then be rewarded on the basis of the number of accesses and quality of his or her contributions in the form of critiques during the accounting period. For each article accessed by reader i during the time period, a score Ai is calculated as follows:

$$Ai = \frac{1}{k} {\sum }_{j = 1}^{k} \frac{1}{{( crj - cij )}^{2} + 1}$$

where cij is the feedback or score given to attribute j of an article by reader i, and each respective term in the summation exists only if reader i assessed and provided a score for attribute j;

k is the total number of possible attributes j of the article being assessed; and

crj is the mean value of attribute j for the particular article being assessed provided by all readers, calculated at the end of the relevant period.

A total score TAi (for all articles accessed by reader i in the accounting period) is then calculated:

$$TAi = {\sum }_{articles}^{p} Ai$$

where p is the total number of articles accessed within the relevant accounting period by reader i.

Thus in this embodiment, the more attributes the reader assesses and for which reader i inputs a score, the greater that reader's Ai for that article as, if reader i chooses not to provide feedback on an attribute he or she is less one term in the formula for Ai. Also, the closer the feedback on attribute j is to mean value crj, the greater is Ai and reader i receives a greater score Ai for that article.

Thus, the number of “reader points” RRi for reader i can be calculated on the basis of the number of articles accessed by reader i and the number of articles scored by reader i as:

RRi=Ei+TAi.

These calculations are repeated each accounting period, and rewards are distributed similarly each accounting period.

When the quality and quantity or all contributions by authors and readers has been determined, contributors are rewarded accordingly. The greater the quantity of items contributed by a user (author or reader), the greater the reward for that user; similarly the greater the quality of items contributed, the greater the reward. The reward can take a number of forms, but will generally comprise either money or recognition. ‘Recognition’ in the case of authors' contributions comprises forwarding a copy of the contribution to a choice of relevant authorities, organizations or persons. These organizations might be, for example, other (possibly more prestigious) publishers, committees—governmental or private—that consider literary works for the award of prizes, or a list of users who have indicated a desire to receive the best contributions, such as by email. Further, the quality of an author's contribution, assessed on the basis of number of accesses, readers' scores, or both, can be forwarded with that contribution. Recognition can also come from scoring both the readers and authors in the forum.

When the rewards are monetary, a fixed proportion of the profit or net income pool of the forum (derived from sales, advertising, etc. within a specific accounting period, typically a day or a week) is divided amongst contributors according to the quantity and quality of their contributions. The server 2 is configured to automatically credit each contributor's nominated bank account with the appropriate reward, at the end of the accounting period.

If, for example, the total revenue for a particular accounting period is X, and it is decided to distribute 30% of that revenue to the readers and 40% to the authors, each reader i would receive:

$$0.3 \times X \times Pi / {\sum }_{i}^{} Pi$$

where Pi is the number of accumulated points (of RRi above) for the accounting period for reader i. Each author j would receive:

$$0.4 \times X \times Pj / {\sum }_{j} Pj$$

where Pj is the number of accumulated points (of TRj above) for the accounting period for author j.

Modifications within the spirit and scope of the invention may be readily effected by those skilled in the art. It is to be understood, therefore, that this invention is not limited to the particular embodiments described by way of example hereinabove.

### INDUSTRIAL APPLICABILITY

The method and apparatus of the present invention provide a useful commercial and technical benefit in the operation and control of online forums, the distribution of income derived from the operation of such forums and the publishing or evaluation of material posted to such forums. These effects can be used to promote the use and success of such forums, and the dissemination of material posted thereto.

The claims defining the invention are as follows:

1. A method of rewarding a contributor for contributing one or more contributions to an electronic publishing environment, comprising:
calculating a reward for said contributor that depends on one or more criteria selected from the group comprising the quantity of said contributions and the quality of each of said contributions, said reward being calculated by said environment.

2. A method as claimed in claim 1, wherein, when said criteria comprise or include said quality of each of said contributions, said method includes determining said quality of each of said contributions.

3. A method as claimed in either claim 1 or 2, wherein, when said criteria comprise or include said quantity of said contributions, said method includes determining said quantity of said contributions.

4. A method as claimed in any one of the preceding claims, including providing said reward, or initiating the provision of said reward.

5. A method as claimed in any one of the preceding claims, wherein the quality of a respective contribution depends on the number of accesses of said respective contribution by readers.

6. A method as claimed in claim 5, wherein said number accesses comprises a number of accesses by unique readers, whereby one of multiple accesses by any reader is used in determining said reward.

7. A method as claimed in any one of the preceding claims, wherein, when said contributor is an author, the quality of a respective contribution depends on a score derived from reader scoring of said respective contribution.

8. A method as claimed in claim 7, wherein said score is derived from a plurality of attribute scores provided by one or more readers, whereby each of said readers scores each of a plurality of attributes of said respective contribution.

9. A method as claimed in any one of the preceding claims, wherein, when said contributor is an author, the quality of a respective contribution depends on the number of subsequent contributions commenting on or responding to said respective contribution and contributed by other contributors.

10. A method as claimed in any one of the preceding claims, wherein said contribution comprises a record indicating that a reader has accessed a previously contributed contribution, so that said reader's accessing said previously contributed contribution constitutes a contribution contributed by said reader, and scoring said previously contributed contribution constitutes an additional contribution contributed by said reader.

11. A method as claimed in any one of the preceding claims, wherein, when said contributor is a reader or critic who provides a contribution that is a critical score for a previously contributed contribution, the quality of the respective contribution depends on an the proximity of said critical score to the mean of all, or a group of, critical scores of said previously contributed contribution.

12. A method as claimed in any one of the preceding claims, wherein said reward is a financial reward, whereby said method includes determining income derived from or associated with said publishing environment over a period of time, and determining said reward on the basis of said income.

13. A method as claimed in any one of claims 1 to 11, wherein said reward comprises forwarding said contributions to a further party, such as another publisher, a funding agency, or a prize awarding organization.

14. A method as claimed in claim 13, wherein said further party is selected according to at least the quality of said contributions, whereby the greater the quality the more prestigious the further party.

15. A method as claimed in any one of claims 1 to 11, wherein said reward comprises scoring each of said contributors in the forum.

16. A method as claimed in any one of the preceding claims, wherein said contributor is one of a plurality of like contributors, and said method includes calculating a respective reward for each of said contributors, wherein said rewards are derived from a reward pool for distribution amongst said contributors.

17. A method as claimed in any one of the preceding claims, wherein said contributor is an author and said contribution is an article, a piece of criticism, a letter or a response to an earlier contribution.

18. An apparatus for rewarding a contributor of one or more contributions to an electronic publishing environment, comprising:
computing means configured or operable to calculate a reward for said contributor that depends on one or more criteria selected from the group comprising the quantity of said contributions and the quality of each of said contributions, said reward being calculated by said environment.

19. An apparatus as claimed in claim 18, wherein, when said criteria comprise or include said quality of each of said contributions, said computing means is configured or operable to receive or calculate values indicative of the quality of each of said contributions, to thereby determine said quality and calculate said reward.

20. An apparatus as claimed in either claim 18 or 19, wherein, when said criteria comprise or include said quantity of said contributions, said computing means is configured or operable to receive or calculate values indicative of said quantity of said contributions.

21. An apparatus as claimed in any one of claims 18 to 20, wherein said computing means includes means for providing said reward, or initiating the provision of said reward.

22. An apparatus as claimed in any one of claims 18 to 21, wherein the quality of each of said contributions depends on the number of accesses of each of said respective contributions by readers.

23. An apparatus as claimed in claim 22, wherein said number accesses comprises a number of accesses by unique readers, whereby one of multiple accesses by any reader is used in determining said reward.

24. An apparatus as claimed in any one of claims 18 to 23, wherein, when said contributor is an author, the quality of a respective contribution depends on a score derived from reader scoring of said respective contribution.

25. An apparatus as claimed in claim 24, wherein said score is derived from a plurality of attribute scores provided by one or more readers, whereby each of said readers scores each of a plurality of attributes of said respective contribution.

26. An apparatus as claimed in any one of claims 18 to 25, wherein, when said contributor is an author, the quality of a respective contribution depends on the number of subsequent contributions commenting on or responding to said respective contribution and contributed by other contributors.

27. An apparatus as claimed in any one of claims 18 to 26, wherein, when said contributor is a critic who provides a contribution comprising critical score for a previously contributed contribution, the quality of said respective contribution depends on an the proximity of said critical score to the mean of all, or a group of, critical scores of said previously contributed contribution.

28. An apparatus as claimed in any one of claims 18 to 27, wherein said reward is a financial reward, whereby said apparatus is operable to determine income derived from or associated with said publishing environment over a period of time, and to determine said reward on the basis of said income.

29. An apparatus as claimed in any one of claims 18 to 27, wherein said reward comprises forwarding said contributions to a further party, such as another publisher, a funding agency, or a prize awarding organization.

30. An apparatus as claimed in any one of claims 18 to 27, wherein said reward comprises recognition from scoring said contributor.

31. An apparatus as claimed in any one of claims 18 to 30, wherein said contributor is one of a plurality of like contributors, and said computing means is operable to calculate a respective reward for each of said contributors, wherein said rewards are derived from a reward pool for distribution amongst said contributors.

32. A method of rewarding a contributor for making one or more contributions to an electronic publishing environment, comprising:
calculating a reward for said contributor that depends on one or more criteria selected from the group comprising the quantity of said contributions and the quality of said contributions, said reward being calculated by said environment.

33. A method as claimed in claim 32, wherein, when said contributor is a reader, accessing a previously contributed contribution constitutes a contribution, so that the quantity of contributions equals or includes the number of previously contributed contributions accessed by said reader.

34. A method as claimed in claim 32, wherein, when said contributor is a reader, accessing a previously contributed contribution constitutes a contribution, scoring a previously contributed contribution constitutes a contribution, or both accessing and scoring a previously contributed contribution constitutes a contribution.

35. A computer provided with or running a computer program encoding the method of rewarding a contributor according to any one of claims 1 to 17 or 32 to 34.

36. A computer readable storage medium provided with a computer program embodying the method of rewarding a contributor according to any one of claims 1 to 17 or 32 to 34.
